(19) United States
(12) Patent Application Publication
(10) Pub. No.: US 2026/0167101 A1
(43) Pub. Date: Jun. 18, 2026

(54) ADAPTIVE INDUSTRIAL VEHICLE LIGHTING CONTROL

(71) Applicant: Deere & Company, Moline, IL (US)

(72) Inventors: SCOTT N. CLARK, BETTENDORF, IA (US); JASON E. HAUBENSTRICKER, DAVENPORT, IA (US)

(21) Appl. No.: 19/535,593

(22) Filed: Feb. 10, 2026

Related U.S. Application Data
(62) Division of application No. 18/438,560, filed on Feb. 12, 2024.

(51) Int. Cl. B60Q 1/50; A01D 90/12; H05B 47/105; H05B 47/165

(52) U.S. Cl. CPC B60Q 1/543; H05B 47/105; H05B 47/165; A01D 90/12

(57) ABSTRACT

A vehicle lighting system configured to alter illumination in response to a detected input may include an agricultural machine including at least one light; and an electronic controller. The electronic controller may include programming instructions to instruct the one or more processors to determine an existence of a relationship of an agricultural machine relative to a location and alter illumination provided by at least one light of the agricultural machine from a first illumination condition to a second illumination condition different from the first illumination condition in response to the determination of the relationship of the agricultural machine relative to the location.

### CROSS-REFERENCE TO RELATED APPLICATIONS

This application is a divisional of U.S. application Ser. No. 18/438,560, titled Adaptive Industrial Vehicle Lighting Control, filed Feb. 12, 2024, which is hereby incorporated by reference in its entirety.

### FIELD OF THE DISCLOSURE

The present disclosure is directed to lighting control of a vehicle and, more particularly, to control of lighting of an agricultural vehicle during reduced ambient lighting conditions.

### BACKGROUND OF THE DISCLOSURE

Agricultural operations, such as planting and harvesting, are time-sensitive. A narrow window of time exists to complete planting and harvesting activities. Factors, such as weather or other considerations, may contribute to an urgency to complete the time-sensitive operations. Therefore, nighttime farming operations are performed in order to complete planting operations or harvesting in a timely manner.

In order to complete nighttime agricultural operations, exterior illumination is used. The illumination allows an operator to conduct nighttime operations.

### SUMMARY OF THE DISCLOSURE

A first aspect of the present disclosure is directed to vehicle lighting system configured to alter illumination in response to a detected input. The vehicle lighting system may include at least one light and an electronic controller. The electronic controller may include one or more processors and a non-transitory computer-readable storage medium coupled to the one or more processors and storing programming instructions for execution by the one or more processors. The programming instructions may instruct the one or more processors to determine an existence of a relationship between a first agricultural machine and a second agricultural machine and alter illumination provided by at least one light from a first illumination condition to a second illumination condition different from the first illumination condition in response to the determination of the relationship between the first agricultural machine and the second agricultural machine.

Another aspect of the present disclosure is directed to a computer-implemented method for controlling illumination from an agricultural vehicle. The computer-implemented method may include determining an existence of a relationship between a first agricultural vehicle and a second agricultural vehicle and altering illumination provided by at least one light of at least one of the first agricultural vehicle and the second agricultural vehicle from a first illumination condition to a second illumination condition different from the first illumination condition in response to the determination of the relationship of the first agricultural vehicle relative to the second agricultural vehicle.

The various aspects of the present disclosure may include one or more of the following features. The programming instructions to instruct the one or more processors to alter illumination provided by the at least one light may include programming instructions to instruct the one or more processors to alter one of a direction of illumination and an amount of illumination output from the at least one light. The programming instructions to instruct the one or more processors to alter one of a direction of illumination and an amount of illumination from the at least one light may include programming instructions to instruct the one or more processors to one of activate and deactivate the at least one light. The programming instructions to instruct the one or more processors to determine the existence of the relationship between the first agricultural machine and the second agricultural machine may include programming instructions to instruct the one or more processors to determine that a distance between the first agricultural machine and the second agricultural machine is equal to or less than a selected distance between the first agricultural machine and the second agricultural machine. The programming instructions to instruct the one or more processors to determine the existence of the relationship between the first agricultural machine and the second agricultural machine may include programming instructions to instruct the one or more processors to determine that the second agricultural machine is within a region relative to the first agricultural machine. The programming instructions to instruct the one or more processors to determine the existence of the relationship of between the first agricultural machine and the location second agricultural machine includes programming instructions to instruct the one or more processors to determine that the second agricultural machine is within a region encompassing the first agricultural machine. A size of the region may be dynamically changing. The programming instructions may include programming instructions to instruct the one or more processors to determine that the relationship between the first agricultural machine and the second agricultural machine no longer exists and return the illumination provided by the at least one light to the first illumination condition in response to the determination that the relationship between the first agricultural machine and the second agricultural machine no longer exists. The programming instructions to alter illumination provided by at least one light from a first illumination condition to a second illumination condition different from the first illumination condition in response to the determination of the relationship between the first agricultural machine and the second agricultural machine may include programming instructions to instruct the one or more processors to determine a current illumination condition of the at least one light of the agricultural vehicle and alter illumination provided by at least one light from the current illumination condition to an altered illumination condition different from the current illumination condition.

The various aspects of the present disclosure may include one or more of the following features. Altering illumination provided by the at least on one light of at least one of the first agricultural vehicle and the second agricultural vehicle from the first illumination condition to the second illumination condition different from the first illumination condition in response to the determination of the relationship of the first agricultural vehicle relative to the second agricultural vehicle may include altering one of a direction of illumination and an amount of illumination from the at least one light. Altering one of a direction of illumination and an amount of illumination from the at least one light may include one of activating and deactivating the at least one light. Altering illumination provided by the at least one light of at least one of the first agricultural vehicle the second agricultural vehicle from the first illumination condition to the second illumination condition different from the first illumination condition in response to the determination of the relationship of the agricultural machine relative to the location may include altering illumination of a light directed towards the first agricultural vehicle. Determining the existence of the relationship between the first agricultural vehicle and the second agricultural vehicle may include determining an existence of a geospatial relationship between the first agricultural vehicle and the second agricultural vehicle. Determining the existence of the relationship between the first agricultural vehicle and the second agricultural vehicle may include determining that a distance between the first agricultural vehicle and the second agricultural vehicle is equal to or less than a selected distance between the first agricultural vehicle and the second agricultural vehicle. Determining the existence of the relationship between the first agricultural vehicle and the second agricultural vehicle may include determining that the second agricultural vehicle is within a region relative to the first agricultural vehicle. Determining the existence of the relationship between the first agricultural vehicle and the second agricultural vehicle may include determining a condition of the first agricultural vehicle. The condition of the first agricultural vehicle may include an unloading condition. The relationship between the first agricultural vehicle and the second agricultural vehicle no longer exists may be determined, and the illumination provided by the at least one light of at least one of the first agricultural vehicle and the second agricultural vehicle may be returned to the first illumination condition in response to the determination that the relationship between the first agricultural vehicle and the second agricultural vehicle no longer exists. A determination that a relationship between a first agricultural vehicle and a second agricultural vehicle no longer exists may be made, and illumination provided by at least one light of at least one of the first agricultural vehicle and second agricultural vehicle may be altered in a manner that signifies that the relationship between the first agricultural vehicle and the second agricultural vehicle no longer exists.

Other features and aspects will become apparent by consideration of the detailed description and accompanying drawings.

### BRIEF DESCRIPTION OF THE DRAWINGS

The detailed description of the drawings refers to the accompanying figures in which:

FIG. 1 is a plan diagrammatic view of an example harvesting operation that includes a combine harvester and a receiving vehicle operating in a field.

FIG. 2 is a plan diagrammatic view of another arrangement for determining when illumination from one or more lights on one or more vehicles is to be altered.

FIG. 3 is a plan diagrammatic view showing a combine harvester and a receiving vehicle in the context of another arrangement in which illumination from one or both of the vehicles can be altered.

FIG. 4 is a schematic view of an example arrangement operable to determine the existence of one or more criteria used to control vehicle illumination.

FIG. 5 is a flowchart of an example method for controlling illumination emitted from a first vehicle.

FIG. 6 is a block diagram illustrating an example computer system used to provide computational functionalities associated with described algorithms, methods, functions, processes, flows, and procedures as described in the present disclosure, according to some implementations of the present disclosure.

### DETAILED DESCRIPTION

For the purposes of promoting an understanding of the principles of the present disclosure, reference will now be made to the implementations illustrated in the drawings, and specific language will be used to describe the same. It will nevertheless be understood that no limitation of the scope of the disclosure is intended. Any alterations and further modifications to the described devices, systems, or methods and any further application of the principles of the present disclosure are fully contemplated as would normally occur to one skilled in the art to which the disclosure relates. In particular, it is fully contemplated that the features, components, and/or steps described with respect to one implementation may be combined with the features, components, and/or steps described with respect to other implementations of the present disclosure.

The present disclosure is directed to controllable lighting on a vehicle. Particularly, the present disclosure is directed to lighting on a vehicle that is controlled, such as automatically, in response to proximity of the vehicle to a location. In some implementations, the location is a location at which another, e.g., second, vehicle is present. Thus, in some implementations, the location is associated with a position of a second vehicle. Further, the second vehicle may be moving, e.g., moving through a field. Consequently, in some implementations, the location is a dynamic location as the location follows the second vehicle as the second vehicle moves.

The present disclosure encompasses altering an illumination condition produced by a light of a first vehicle, for example, when the first vehicle is at a selected distance relative to a second vehicle, when the first vehicle is within a region that encompasses the second vehicle, when the first vehicle is in a zone relative to the second vehicle, when the first vehicle has a position and a selected heading relative to the second vehicle, when a configuration of the second vehicle changes to a selected configuration (e.g., when the second vehicle changes into an unloading configuration), and when a communication link is established between the first vehicle and the second vehicle. Additionally, the illumination condition of the first vehicle may be altered based on a present illumination condition of the first vehicle.

The present disclosure is provided in the agricultural context. However, the scope of the present disclosure is not so limited. Rather, the scope of the present disclosure encompasses other industries and applications that involve exterior lighting or illumination in low ambient light conditions. Agricultural machines, e.g., harvesting vehicle, seeding vehicle, planting vehicles, spraying vehicles, etc., perform operations during low ambient light conditions, e.g., nighttime conditions. Further, during many agricultural operations, multiple vehicles are involved in performing the agricultural operation, including multiple vehicles that come into close proximity to each other. For example, during a harvesting operation, a combine harvester collects harvested crop, including processed harvested crop. The harvested crop is temporarily stored onboard of the combine harvester, such as in a grain tank or bin. To allow the combine harvester to continue to harvest when the grain tank fills or reaches a selected fill level, another vehicle is generally used to offload the collected crop. The other vehicle may include a grain cart or other storage container carried by, pulled, or otherwise conveyed by another machine, such as a tractor. The other vehicle, which may be referred to as a receiving or secondary vehicle, comes into close proximity with the combine harvester prior to, during, and following an unloading operation.

While vehicle illumination can improve visibility during nighttime operations, vehicle illumination, in other contexts during nighttime operations, can hinder visibility to an operator of a vehicle. For example, during nighttime agricultural harvesting operations, as the receiving vehicle approaches the combine harvester to perform an unloading operation, the exterior illumination produced by the receiving vehicle can hinder or otherwise diminish visibility of the operator of the combine harvester, particularly when the receiving vehicle converges on the combine harvester in a head-to-head manner.

To reduce or eliminate this risk, the present disclosure provides for an alteration to the illumination provided by the receiving vehicle (e.g., a first vehicle), the combine harvester (e.g., a second vehicle), or both. In some implementation, the alteration to the illumination provided by one or more vehicles automatically upon an occurrence of one or more criteria.

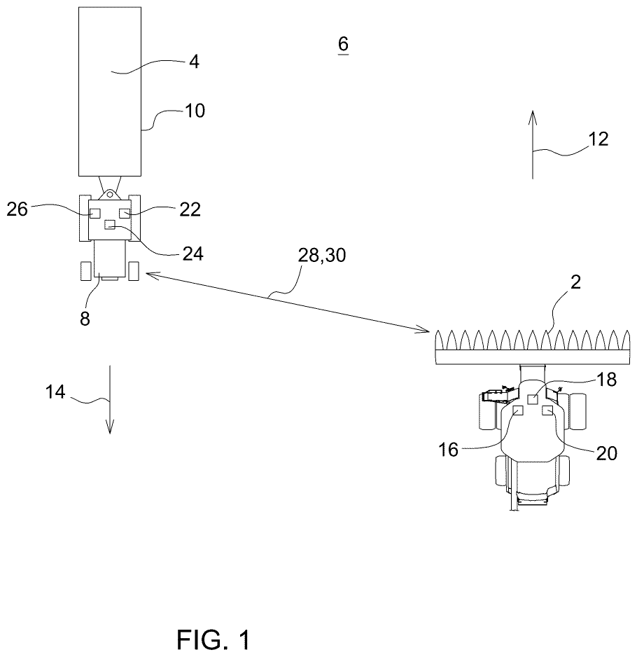

FIG. 1 is a plan diagrammatic view of an example harvesting operation that includes a combine harvester 2 and a receiving vehicle 4 operating in a field 6. In the illustrated example, the receiving vehicle includes a tractor 8 and a grain cart 10 pulled by the tractor 8. In other implementations, the receiving vehicle 4 may be a self-propelled grain cart or other vehicle or combination of vehicle adapted to receive grain from a combine harvester, such as combine harvester 2. As shown, the combine harvester 2 and the receiving vehicle 4 are laterally offset and traveling in opposing or approximately opposing direction. The combine harvester 2 is moving in the direction of arrow 12, and the receiving vehicle 4 is moving the direction of arrow 14. Consequently, the two vehicles are in an offset face-to-face orientation.

The combine harvester 2 includes lights 16, 18, and 20, and the receiving vehicle 4 includes lights 22, 24, and 26. Although three lights for each of the vehicles 2 and 4 are illustrated, the scope of the present disclosure is not so limited. Rather, each vehicle may include different numbers of lights. Further, additional or fewer lights may be included on one or both vehicles.

The combine harvester 2 and the receiving vehicle 4 are separated by a distance 28, indicated by arrow 30. In this example, when the distance 28 separating the combine harvester 2 and the receiving vehicle 4 satisfied a selected criteria, e.g., when the distance become equal to or less than a selected distance, illumination from the receiving vehicle 4, the combine harvester 2, or both can be altered. For example, when the distance 28 meets a selected criteria, e.g., the distance 28 is equal to or less than a selected distance, one or more of lights 22, 24, and 26 of the receiving vehicles is altered. For instance, the lights 22 or 22 and 24 may be altered as some portion of the illumination produced by the lights 22 and 24 is likely to be directed towards the operator of the combine harvester 2. This portion of the illumination may affect the ability of the operator to see into the field 6. As a result, the operator's ability, for example, to remain on course, see an obstacle, or to see and recognize a boundary of the field 6 may be reduced or otherwise affected. Thus, by altering the illumination produced by the lights 22 and 24, the ability of the operator of the combine harvester 2 to see into the field and effectively perform the harvesting operation is enhanced.

The illumination from the lights may be altered such as by adjusting an amount of illumination provided by one or more of the lights (e.g., reducing an amount of light emitted from the lights), turning off the lights so that no illumination is produced by one or more of the lights, turning on one or more lights (e.g., one or more lights at an interface), redirecting illumination from one or more of the lights such that the illumination from the lights is directed into a different direction, or altering a color of illumination (i.e., a frequency of light) produced by one or more of the lights. In some implementations, a combination of these alterations may be used. In some implementations, such as in an autonomous operation where human operators are not present within one or both of the vehicles 2 or 4, illumination from one or more of the lights 16, 18, 20, 22, 24, or 26 may be altered so that performance of one or more sensors on the vehicles 2 or 4 is improved or maintained at a desired level.

In some implementations, in addition to the receiving vehicle 4 and the combine harvester 2 being at or less than a selected distance from each other, an alteration to illumination may depend on a heading of the receiving vehicle 4 relative to the combine harvester. For example, if the receiving vehicle 4 has a heading that is 180° (as measured, for example, by a magnetic compass) opposite of the heading of the combine harvester 2 or has a heading within a range of headings relative to the combine harvester 2 (e.g., plus and minus 90° from a heading that is opposite to the heading of the combine harvester 2), then an alteration to the illumination occurs when the receiving vehicle 4 is equal to or less than a selected distance from the combine harvester 2. In some implementations, illumination from one or more of the lights may be returned to an initial illumination level when the heading no longer satisfies the criteria, even if a distance separating the receiving vehicle 4 and the combine harvester 2 is equal to or less than the distance 28.

Further, in some implementations, illumination from one or more of the lights may be subsequently altered based on a change in a heading (or some other criteria). For example, in a situation in which the receiving vehicle 4 and the combine harvester 2 are approaching in a head-on relationship, illumination from lights 24 and 22 may be altered, e.g., dimmed, directed in another direction, deactivated, etc., when the two vehicles 2 and 4 are within a selected proximity of each other. As explained herein, a plurality of criteria may be used to determine when illumination is to be altered. Here, the heading of the receiving vehicle 4 relative to the combine harvester 2 and whether the receiving vehicle 4 is within a geospatial zone relative to the combine harvester 2 or is a selected distance from the combine harvester 2 are criteria used in this example. In the case that the receiving vehicle 4 passes the combine harvester 2 and then turns to approach the combine harvester 2 from the rear (such as in anticipation of an unloading operation), the change in heading may be used to alter the illumination of the lights 22, 24, and 26, such that illumination from lights 24 and 22 may be returned to an initial illumination condition (or to some other illumination condition) and illumination from light 26 may be altered. Alternatively, illumination from light 22 may be returned to an initial illumination condition (or some other illumination condition), and illumination from lights 24 and 26 may be altered to a desired condition. Thus, a change in one or more criteria may cause a change to an illumination condition from one or more lights.

Iin still other implementations, illumination may be altered, whether alone or in combination with other criteria (such as the criteria described herein), when the receiving vehicle 4 is at a location relative to the combine harvester 2. For example, notwithstanding a heading of the receiving vehicle 4, if the receiving vehicle 4 is in front of the combine harvester 2, illumination from one or more of the lights of the receiving vehicle 4 may be altered. Further, lights from which illumination is altered may be determined based on, for example, an orientation of the receiving vehicle 4 relative to the combine harvester (e.g., the heading of the receiving vehicle 4 relative to the combine harvester 4), a location of the receiving vehicle relative to the combine harvester 2 (e.g., in front of the combine harvester, behind the combine harvester, or beside the combine harvester), or both. Thus, one or more lights from which illumination may be altered may be different when the receiving vehicle is heading in an opposite direction of the combine harvester 2 as opposed to moving in the same direction as the combine harvester 2. Thus, which lights may have illumination altered can be dynamically determined based on one or more criteria.

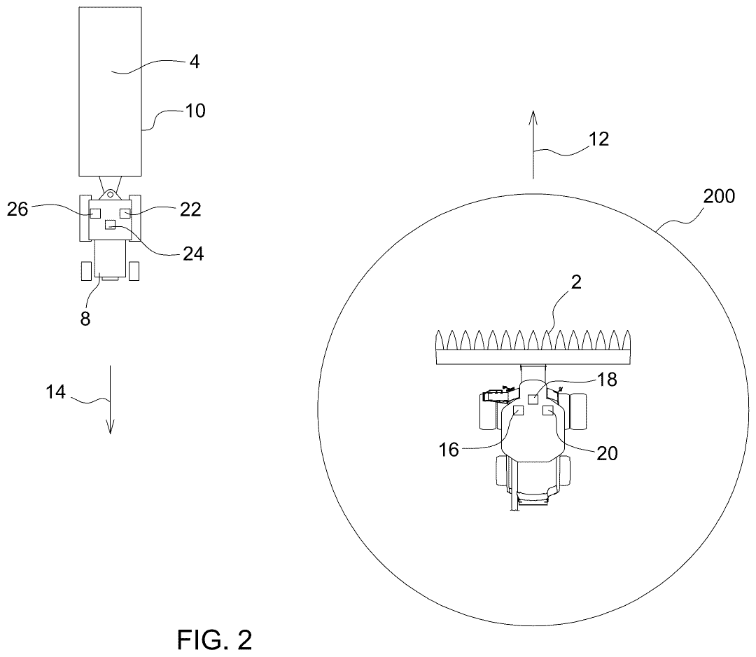

FIG. 2 is a plan diagrammatic view of another arrangement for determining when illumination from one or more lights on one or more vehicles (in this instance, agricultural vehicles) is to be altered. In FIG. 2, illumination from a vehicle is altered in response to a vehicle, in this example, the receiving vehicle 2, being in a geospatial region 200 bordering or surrounding another vehicle, in this example, the combine harvester 2. Thus, for example, when the receiving vehicle 4 is within the geospatial region 200 surrounding and in which the combine harvester 2 is present, illumination from one or more lights 22, 24, or 26 is altered, such as in a manner explained earlier. Further, intrusion of the receiving vehicle 4 into the geospatial region 200 may cause illumination from one or more of lights 16, 18, and 20 to be altered. In some implementations, alteration to the illumination occurs as soon as the receiving vehicle 4 intrudes into the geospatial region 200, regardless of a heading of the receiving vehicle 4 relative to the combine harvester 2.

In other implementations, an alteration to the illumination when the receiving vehicle 4 enters the geospatial region 200 may depend on a heading of the receiving vehicle 4 relative to the combine harvester 2, a position of the receiving vehicle 4 relative to the combine harvester 2, or both, as explained in more detail below. For example, in some implementations, illumination may be altered when the receiving vehicle 4 both enters the geospatial region 200, is at a position in front of the combine harvester 2 (even if the receiving vehicle 4 is laterally offset from the combine harvester 2), and has a heading satisfying a heading criteria (e.g., the receiving vehicle 4 is approaching the combine harvester 2 head on in a direction as shown in FIG. 2). In some implementations, the heading criteria is a range of headings of the receiving vehicle 4 relative to the combine harvester 2. For example, in some implementations, a range of headings satisfying a heading criteria is plus or minus a selected heading of the combine harvester 2. For example, if the combine harvester 2 is moving at 0° (or 360°) as measured by a magnetic compass, for example, and the receiving vehicle 4 is in the geospatial region 200, the heading criteria that would cause an alteration to illumination from one or more lights may be the heading of the combine harvester 2 plus 180° (i.e., 180° direction based on a magnetic compass). Further, in some implementations, the heading criteria may include a range of headings relative to the heading of the combine harvester. For example, the heading criteria may be plus and minus 90° of a heading that is 180° from the heading of the combine harvester 2. Thus, if the combine harvester 2 is heading at 0° magnetic, and the receiving vehicle 4 has a heading that is anywhere within the range of 90° magnetic to 270° magnetic and the receiving vehicle 4 has intruded into the geospatial region 200, an alteration to the illumination is triggered.

Although examples are provided based on the receiving vehicle 4 having a heading that is 180° relative to the combine harvester 4, the scope of the present disclosure is not so limited. Rather, the heading criteria may be selected to be any heading or range of headings of the receiving vehicle 4 relative to the combine harvester 2.

In the illustrated example, the geospatial region 200 is a circular region whose center is at a location on the agricultural harvester 2. In other implementations, the geospatial region has a different shape. The scope of the present disclosure encompasses a geospatial region with any desired shape, such as square, rectangular, triangular, any polygon, or any other desired shape. Further, the center of the geospatial region may be located anywhere on or relative to the combine harvester 2 (or another relevant vehicle). Intrusion of the receiving vehicle 4 into the geospatial region 200 causes an alteration to illumination from one or more lights on the receiving vehicle 4, one or more lights on the combine harvester 2, or both. As explained above, although each of the vehicles 2 and 4 include three lights, one or both of the vehicles 2 and 4 may include additional or fewer lights.

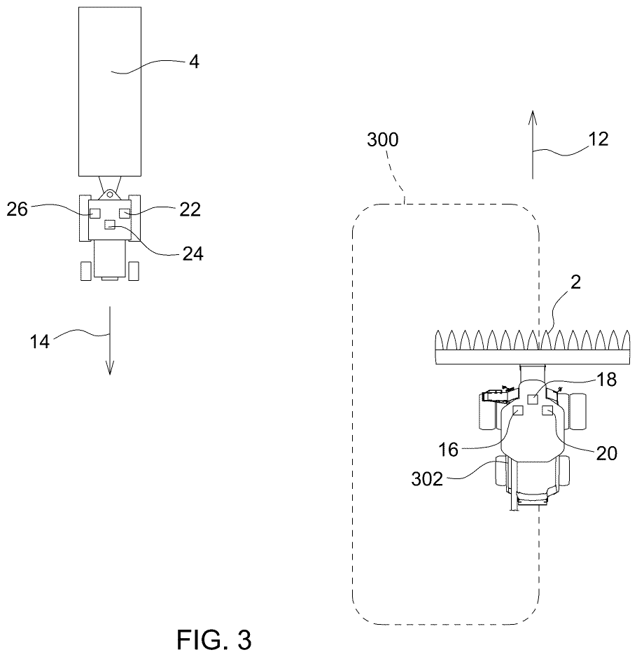

FIG. 3 is another plan diagrammatic view showing the combine harvester 2 and the receiving vehicle 4 in the context of another arrangement in which illumination from one or both of the vehicles 2 and 4 can be altered. FIG. 3 shows a geospatial region 300 defined relative to the combine harvester 2. The geospatial region 300 may represent a subset of the geospatial region described above in the context of FIG. 2. In FIG. 3, the geospatial region 300 does not envelope the combine harvester 2. Rather, the geospatial region 300 is defined along a side 302 of the combine harvester 2. Here, in the illustrated example, the geospatial region 300 defines a region on the left side 302 of the combine harvester 2 that corresponds to an unload zone. Although an example of the geospatial region 302 is shown as being on the left side 320 of the combine harvester 2, the scope of the disclosure is not so limited. Rather, the geospatial region 300 may be defined to be a region at any desired portion of the combine harvester 2, such as bordering along a right side, front end, or back end of the combine harvester 2.

The unload zone is an area adjacent to the combine harvester 2 in which the receiving vehicle 4 is present (entirely or partially) to receive grain offloaded by the combine harvester 2, whether the offloading process occur statically (i.e., with the combine harvester 2 in a stationary condition) or dynamically (i.e., with the combine harvester 2 moving while offloading). An example dynamic offloading process is one in which offloading of grain from the combine harvester 2 occurs in combination with continued movement of the combine harvester 2 through a field. For example, during a dynamic offloading process, the combine harvester 2 may continue harvesting of crop in the field 6 while offloading of processed grain occurs.

In some implementations, as explained above, whether the illumination is altered based on the receiving vehicle 4 intruding into the geospatial region 300 may depend upon the heading of the receiving vehicle relative to the combine harvester 4. Thus, incursion of the receiving vehicle 4 into the offloading zone (represented in this example as geospatial region 300) may cause alteration to the illumination provided by one or more lights when the receiving vehicle 4 has a selected heading, whether an absolute heading (e.g., a magnetic heading) or a heading relative to the combine harvester 2. As explained above, the heading may be a single heading or a range of headings that causes alteration to the illumination from one or more lights. Further, as also explained above, the lights having altered illumination may be one or more lights 22, 24, 26 on the receiving vehicle 6, one or more lights 16, 18, 20 on the combine harvester 2, or both.

In some implementations, an alteration to illumination occurs based on the existence of more than one criteria. For example, in some instances, illumination is altered when the receiving vehicle 6 has both a selected heading or a heading within a selected range of headings relative to the combine harvester and the receiving vehicle 6 is within the geospatial region 300. In some implementations, illumination is altered when at least one of the selected criteria exists.

Further, as also previously explained, illumination is restored to an initial illumination condition when one or all of the criteria no longer exist. For example, where illumination is altered when the heading of the receiving vehicle is a selected heading or within a selected range of headings and when the receiving vehicle is within a geospatial region, the illumination is returned to the initial illumination condition when one or all of the criteria are no longer satisfied. For example, illumination from the one or more lights is returned to an initial, unaltered condition when the receiving vehicle no longer has the selected heading (e.g., a heading relative to the combine harvester), is no longer intruding into the geospatial region, or both. Thus, the illumination provided by one or more lights could be changed (e.g., altered from an initial condition or returned to the initial condition) in response to one, a group, or all criteria being satisfied or no longer satisfied.

In some implementations, alteration to illumination from one or more lights on a vehicle, e.g., a receiving vehicle or a combine harvester, may be made contingent on a configuration of one or both of the vehicles. For example, in some implementations, illumination from one or more lights 22, 24, 26 of the receiving vehicle 4, one or more lights 16, 18, 20 on the combine harvester 2, or both is altered when an unloader of the combine harvester 2 is moved into an extended position. The unloader is a conveyor that is used to unload grain from the combine harvester 2 to the receiving vehicle 4. As previously explained, a change in configuration of the combine harvester 2 (or the receiving vehicle 4 or another vehicle), alone, may cause an alteration to the illumination from one or more lights. Alternatively, the change in configuration may be one of a plurality of criteria, one, several, or all of which must be present to alter the illumination. Further, a change of the vehicle back to the original configuration, e.g., retracting the unloader, may cause the illumination to return to the initial condition. Other examples include a change in configuration to an auger, spout, elevator, conveyor, tending arm, or other component or attachment. Further, as explained earlier, the scope of this disclosure encompasses types of agricultural vehicles other than harvesters. Thus, a change to a component or systems such as these or others of other types of agricultural vehicles (e.g., self-propelled forage harvesters, sugar cane harvesters, specialty harvesters, and commodity handlers) can be used as criteria for determining when to alter illumination. In some implementations, returning the vehicle to an initial configuration in combination with one or more other criteria causes the illumination to return to an initial condition. Thus, illumination may return to an initial condition when a configuration of the vehicle is returned to an initial or different condition and another, some, or all other criteria for altering the illumination no longer exists.

Changes to vehicle illumination may also occur in other instances. For example, in the course of an agricultural operation, a communication link may be established between two or more vehicles operating in a field. In some instances, the communication link is a wireless communication link. A communication link includes, for example, a communication link occurring when two vehicles come within a selected distance from each other (e.g., when a signal received by one or both of the vehicles is at a selected level); when an input from one vehicle in communication with another vehicle is received (e.g., when the receiving machine 4 receives an indication by the combine harvester 2 that an unload operation is needed or desired); when control of one vehicle is taken by the other vehicle, either by an operator of the other vehicle or by an autonomous system (e.g., when control of the receiving vehicle 4 is taken by the combine harvester 2, such as during a dynamic unloading operation or when a commodity is being dynamically delivered to another vehicle, also referred to as an on-the-go commodity delivery operation). An on-the-go commodity delivery operation is one in which a commodity, such as a fertilizer, is provided from a first vehicle to a commodity delivery vehicle while the commodity delivery vehicle continues to move over a surface, such as through a field.

A communication link between one or more vehicles may cause illumination from one or more lights on one or more of the vehicle in communication to become altered, such as in a manner descried herein. Further, in some implementations, establishment of a communications link may be the sole cause of an alteration to illumination, whereas, in other implementations, establishment of a communications link may be one of a plurality of criteria required to alter illumination. For example, in some instances, a plurality of criteria to cause alteration to illumination may exist, including establishment of a communication link. Further, adjustment to the illumination from one or more vehicle lights may occur in response to satisfaction of all of those criteria, some of those criteria, or a single one of the criteria. Thus, establishment of a communication link, alone, or in addition to one or more other criteria, may cause an illumination adjustment. Further, the loss or termination of the communication link, alone, or in combination with one or more other criteria that ceases to exist, may cause return of the illumination to the previous level or a different level. Return of illumination to a previous condition or level when a communication link is lost or discontinued may be used as an indication or alert that the communication link has been lost. In some instances, loss of a communication link triggers a type of illumination or sequence of illumination. This type or sequence of illumination operates as an alert that a communication link has been lost. Thus, in some implementations, a change to illumination may occur based on satisfaction of one or more of the following example criteria: a distance between two vehicles, incursion of a vehicle into a geospatial area associated with a second vehicle, an absolute heading of one vehicle, a relative heading of one vehicle relative to another vehicle, a communication status between two or more vehicles, or a position of one vehicle relative to another. Still further, illumination to revert to the previous illumination condition may occur when the loss of one or more of the criteria ceases to be satisfied, even if the communication link remains established.

In some instances, establishment of a communication link between vehicles, such as two vehicles, may not automatically cause an alteration to illumination from one or more vehicle lights. In some instances, a command from one vehicle to the other after establishment of the communication link causes the alteration to the illumination. In other implementations, identification of a type of vehicle with which a communication link has been established is the cause of the alteration to the illumination. That is, establishment of the link is not the trigger for altering the illumination. Rather, in some instances, an identification transmitted from one vehicle to the other is what causes the alteration to the illumination. For example, after a communication link is established between a receiving vehicle and a combine harvester, the combine harvester may receive information from the receiving vehicle that identifies the type of vehicle that the receiving vehicle is. In this example, this identification of vehicle type causes the adjustment to the illumination.

In some instances, communication transmitted via an established communication link is what triggers an illumination adjustment. For example, the communication may include one or more pieces of information about the vehicle transmitting the information. For example, the communication may include one or more of the following pieces of information: position information, orientation information, heading information, speed information, and information regarding a relationship between the vehicles in communication. In some implementations, additional, fewer, or other types of information may be included in the communication between vehicles. Any one of the pieces of information included in the transmitted communication or a combination of a group of the pieces of information may cause the alteration to the illumination.

In some instances, the transmitted communication may include a command to cause the change to the illumination. For example, in some implementations, a receiving vehicle and a combine harvester may form a communication link with each other. The receiving vehicle may transmit information to the combine harvester, including information that identifies the receiving vehicle as such. In response to the combine harvester receiving this information (e.g., that the vehicle in communication is a receiving vehicle), the combine harvester transmits a command to the receiving vehicle to cause an alteration to illumination from one or more of the lights of the receiving vehicle. In some instances, the transmitted command to alter illumination may be, for example, predefined illumination setting or a user defined illumination setting, whether preselected or selected at the time that the communication link is established. As described earlier, alteration to the illumination may be the result of a combination of criteria being present such as information that identifies a type of vehicle as well as one more other criteria being satisfied (e.g., geospatial position, heading, vehicle configuration, etc.).

Other types of information transmitted during a communication link between vehicles may also be used to or cause an alteration in illumination from one, several, or all vehicles in the communication link. In some implementations, one or more pieces of information, such as vehicle availability condition (e.g., available or unavailable condition), an en route travel condition (e.g., the vehicles are converging), a vehicle approaching condition (e.g., a geospatial position of one vehicle relative to another or one vehicle being present within a geospatial boundary relative to another vehicle), a vehicle configuration condition (e.g., a combine harvester is in an unloading configuration), and a departing condition (e.g., one vehicle is in the process of departing from another), included in one or more transmissions from one vehicle to another is used to alter illumination (either to alter an illumination condition or to return the illumination condition to a previous condition) of one or more of the vehicles.

In some implementations, communication between vehicles is indirect. That is, each vehicle may be in communication with a remote location, such as a remote computer system (which may be similar to computer system 402, described in more detail below), and each vehicles communicates with the remote computer system. The remote computer system communicates information received from one vehicle to the other. Although one remote computer system is described in other implementations a plurality of remote computer systems may be used to provide communication between two or more vehicles, such as two or more agricultural vehicles operating in a field. Thus, in some implementations, two or more vehicles may be in communication with each other indirectly via one or more remote computer systems.

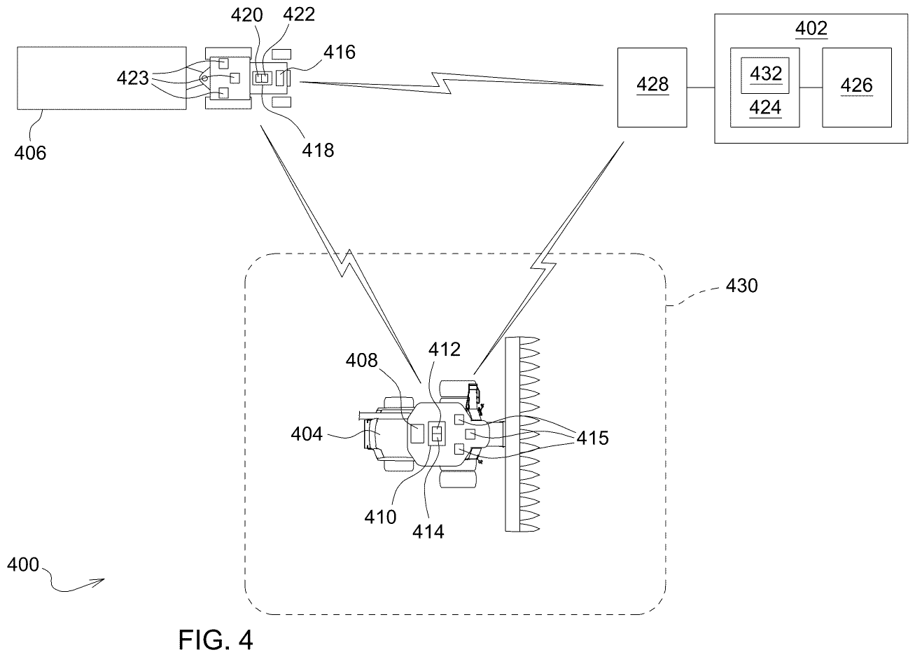

The determination of the existence of the various conditions or criteria that are used to alter illumination of one or more lights of a vehicle can occur in numerous ways. FIG. 4 is a schematic view of one example arrangement operable to determine the existence of one or more criteria used to control vehicle illumination. FIG. 4 shows a communication system 400 that includes a remotely located computer system 402, which may be similar to the computer system 600 discussed in more detail below, a first vehicle 404, and a second vehicle 406. In this example, the first vehicle 404 is a combine harvester (which may be similar to combine harvester 2), and the second vehicle 406 is a receiving vehicle (which may be similar to receiving vehicle 4). The first vehicle 404 includes a global navigation satellite system (GNSS) receiver 408 and a control system 410. In some implementations, the control system 410 includes a computer system 412, similar to computer system 600, and a transceiver 414 configured to receive and transmit information wirelessly. Similarly, the second vehicle 406 includes a GNSS receiver 416, similar to GNSS receiver 408, and a control system 418, similar to control system 410. Thus, in some implementations, the control system 414 includes a computer system 420, similar to computer system 600, and a transceiver 422 configured to receive and transmit information wirelessly. The first vehicle 404 includes lights 415, and the second vehicle 406 includes lights 423. Illumination from lights 415 and 423 are adjustable. Further, although three lights 415 and three lights 423 are illustrated, additional or fewer lights may be included. Further, in some instances, illumination from the different lights are independently controlled. In still other instances, illumination from one or more of the lights 415 or 423 are alterable while illumination from one or more other lights 415 or 423 are not alterable.

The remotely located computer system 402 includes a processor 424 and a memory 426, similar to the processor 605 and memory 607 described in more detail below. The computer system 402 also includes or is connected to a transceiver 428. The computer system 402 utilizes the transceiver 420 to receive and transmit information wirelessly, such as to the first and second vehicles 404 and 406. Although transceivers are described in the context of the remotely located computer system 402, the first vehicle 404, and the second vehicle 406, in some implementations, a separate receiver and transmitter could be used.

In operation, the GNSS receivers 408 and 416 utilize satellite signals to determine a position of the respective vehicles 404 and 406 on the surface of the Earth. This position information is transmitted wirelessly using, for example, a wireless communication protocol. Example wireless protocols are described below. However, the scope of the present disclosure encompasses any wireless communication protocol, method, or technology operable to transmit information from one location to another.

In some implementations, the position information from the first vehicle 404 and the second vehicle 406 is transmitted to the remotely located computer system 402. In some instances, the position information includes one or more of the following pieces of information: a geospatial location of a vehicle (i.e., a position of the vehicle on the Earth), a heading of the vehicle, and a speed of the vehicle. Additionally, the remotely located computer system 402 may also include information associated with criteria used to determine when an alteration to vehicle illumination is appropriate, such as the various criteria and conditions described earlier. This information includes, for example, a distance that, if the distance between the vehicles become equal to or less than the distance, causes an alteration to one or more vehicle lights; a geospatial region (e.g., geospatial region 430) that, if encroached by a vehicle, causes alteration to the illumination; an operating configuration of a vehicle; whether a communication link is established between vehicles; or other criteria or conditions described herein or otherwise within the scope of the present disclosure. In some implementations, the criteria information may be transmitted to the computer system 402 by one or both of the vehicles. In some implementations, the criteria information is transmitted directly from one vehicle to another. Thus, information may be wirelessly transmitted from one vehicle to another directly or indirectly.

In some instances, a location of a vehicle in a field may be within a selected distance from a roadway. In such instances, when the vehicle is within a selected distance from a roadway, illumination from one or more lights of the vehicle may be altered. Alteration of illumination from one or more lights in this manner can be used to reduce illumination directed to or along the roadway and, thereby, reduce or eliminate light that may produce glare or otherwise reduce visibility of other vehicles passing along the roadway. In some implementations, proximity to the roadway is the sole criteria used to alter illumination from one or more lights on the vehicle operating in a field. In other implementations, other criteria may be used. For example, in some instances, proximity to a roadway is one of a plurality of criteria used to determine whether to alter illumination from the vehicle. For example, in addition to proximity to a roadway, a heading of the vehicle in the field may also be used as a criteria for determining whether to alter illumination from the vehicle in the field.

The transceiver 428 receives this information from the first and second vehicles 404 and 406. In some implementations, the computer system 402 stores this position information. In some instances, the computer system 402 includes software that is operable to display a location of each vehicle relative to each other. For example, the computer system 402 may include mapping software 432 that is operable to map locations of the vehicles 404 and 406 relative to each other. In some implementations, software, such as software 432, includes a series of instructions that, when executed by a processor (e.g., processor 424) cause the processor to perform one or more functions. For example, the mapping software 432 may cause the processor 424 to map locations of the vehicles 404 and 406 based on information received from the vehicles 404 and 406 or other information that provides a location of the vehicle 404, vehicle 406, or both.

In some implementations, the computer system 402 transmits the position information of each vehicle to the other. Particularly, the computer system 402 transmits position information from the first vehicle 404 to the second vehicle 406 and transmits the position information from the second vehicle 406 to the first vehicle 404. Each of the first and second vehicles 404 and 406 may use the position information associated with the other vehicle to determine, for example, one or more of a location of the other vehicle relative to itself and a heading of the other vehicle relative to itself. One or both of the vehicles uses this information to determine whether illumination from one or more vehicle lights should be altered. The criteria used to make this determination may the example criteria described herein or otherwise within the scope of the present disclosure.

As an example, the first vehicle 404 receives a position of the second vehicle 406 via transceiver 414. The first vehicle 404 may receive this information directly from the second vehicle 406 or indirectly from the second vehicle 406 via the remotely located computer system 402. The computer system 412 of the first vehicle 404 determines whether the second vehicle 406 is within geospatial region 430. If the position of the second vehicle 406 is not within the geospatial region 430, then an alteration to vehicle illumination is not needed. If the second vehicle 406 were within or had otherwise encroached into the geospatial region 430, the computer system 412 determines the encroachment of the second vehicle into the geospatial region 430 using the position information of the second vehicle. As a result, in some instances, an adjustment to illumination is determined onboard of the first vehicle 404. In other implementations, the second vehicle 406 receives information that is used to determine whether criteria satisfied in order to adjust illumination, and causes adjustment to the illumination adjustment, e.g., by altering one or more lights 423 of the second vehicle 406, transmitting a signal to the first vehicle 404 to cause a change in illumination from the lights 415 of the first vehicle 406, or both. As explained earlier, communications between vehicles 404 and 406 may be direct communications or indirect communications, such as communications made through remotely located computer system 402.

In some implementations, whether an adjustment to illumination of a vehicle, such as vehicle 402, 406, or both is needed, may be performed by the remotely located computer system 402, the computer system 412, computer system 420, or a combination of these. Thus, in some instances, the processing to determine whether an adjustment to illumination is needed may be confined to one of these computers systems or may be distributed across some or all of these computer systems.

In some implementations, one or more of the vehicles 404 and 406 are identified using a sensor. For example, the first vehicle 404 may include a sensor that is configured to sense another vehicle, such as the second vehicle 406, and this sensed information is used to identify the second vehicle 406. Similarly, in some instances, the second vehicle 406 may include a sensor configured to sense another vehicle, such as the first vehicle 404, and this sensed information is used to identify the first vehicle 404. Example sensor types include optical sensors, such as a camera, lidar, or radar. Cameras include visible light cameras, infrared cameras, stereo cameras, or video cameras. Other types of optical sensors are within the scope of the present disclosure.

Data from a sensor is used to identify a vehicle, such as with the use of an identifier tag (e.g., an AprilTag), object recognition, or another type of data analysis, including, e.g., artificial intelligence or machine learning. The data obtained from a sensor may also be used to determine a speed, direction, or configuration of another vehicle, and this information may be used in a manner similar to that explained earlier to alter an illumination level from a vehicle.

In still other implementations, an illumination level of a light on a vehicle may be altered remotely from a device, such as a mobile device (e.g., a tablet, smartphone, or mobile device). A user may use the device to alter illumination of a vehicle remotely from a fixed location or from onboard of the vehicle or another vehicle.

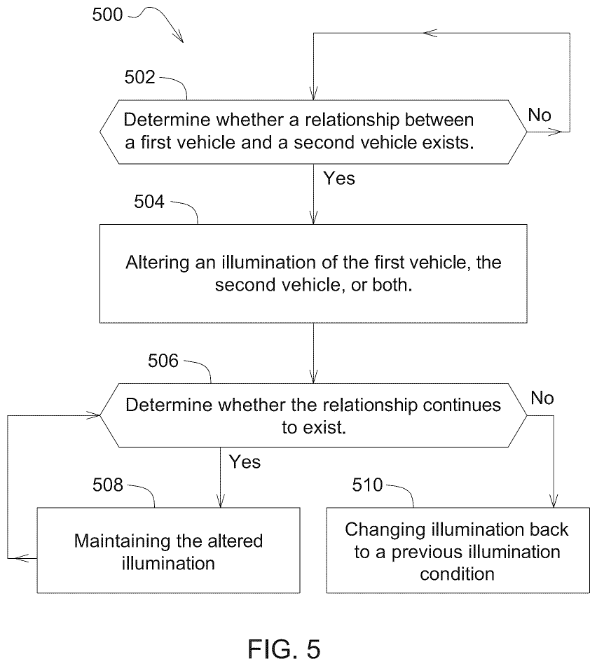

FIG. 5 is a flowchart of an example method for controlling illumination emitted from a first vehicle. Control of the illumination includes, for example, controlling whether a light source is activated or deactivated, controlling a direction of illumination, color of illumination, and an amount of illumination produced by one or more lights of the vehicle. Control of the illumination of the first vehicle is made in response to a relationship between the first vehicle and a second vehicle. The second vehicle may be stationary or moving.

At 502, a relationship between the first vehicle and the second vehicle is determined. In some implementations, the relationship is determined based on the existence of one or more criteria. The satisfaction of one or more criteria determines whether the relationship exits and, thus, whether the illumination is altered. The one or more criteria includes one or more of the criteria described above. For example, illumination from the first vehicle may be altered in response the second vehicle being a selected distance from the first vehicle or the second vehicle entering a geospatial region relative to the first vehicle. Another criteria is a direction of movement of the second vehicle. For example, a direction in which the second vehicle is moving, i.e., a heading of the second vehicle, is used to determine whether illumination from the first vehicle is altered. For example, as explained earlier, if the heading of the second vehicle of the second vehicle relative to the first vehicle is a selected heading or within a selected range of headings, then illumination of the first vehicle is altered.

Further, in some implementations, the criteria includes whether a communication link is established between the first vehicle and the second vehicle. For example, as explained above, the existence of a communication status between the first vehicle and the second vehicle is used to establish the relationship between the first and second vehicle or is a criteria used to determine the existence of the relationship. For example, a communication link established between the first vehicle and the second vehicle may be criteria, either alone or in combination with other criteria, to cause an alteration to illumination from the first vehicle, the second vehicle, or both. A communication link established between the first vehicle and the second vehicle includes direct communication and indirect communication. Indirect communication includes communication via a third location, such as a remotely located computer system, such as remotely located computer system 402. The criteria may also include recognition of a vehicle using a sensor, such as the recognition of the first vehicle or second vehicle based on output from a sensor located on the other of the first vehicle or the second vehicle, as described earlier.

The communication link may include providing a variety of information from one vehicle to the other. The existence of the communication link or in response to information contained in the communication provided via communication link is usable to alter illumination from the first vehicle, the second vehicle, or both.

If the relationship between the first vehicle and the second vehicle is determined to exist, then, at 504, illumination from the first vehicle, the second vehicle, or both is altered in response to a determination that a relationship. As explained above, alteration of illumination includes altering one or more of the amount of illumination (including whether one or more lights is activated or deactivated), a direction of illumination, and a color of illumination. An alteration of the illumination alters the illumination from a first illumination condition to a second, different illumination condition. At the relationship is determined not to exist, then, in some implementations, the method 500 returns to 502 and continues to monitor for the presence of the relationship.

At 506, a determination is made as to whether the relationship continues to exist. If the relationship no longer exits, i.e., if one or more of the criteria required to alter the illumination is no longer satisfied, then the illumination condition is changed. At 508, if the criteria establishing the relationship are still satisfied, then the alteration to the illumination is maintained, and the method returns to 506. At 510, if one or more of the criteria that define the existence of the relationship are no longer satisfied, then the illumination is changed. For example, the illumination condition is changed back to a previous illumination condition. Thus, for example, when the relationship no longer exists, the illumination condition returns from the second illumination condition to the first illumination condition.

Without in any way limiting the scope, interpretation, or application of the claims appearing below, a technical effect of one or more of the example implementations disclosed herein is improving visibility of an operator of an agricultural vehicle during nighttime operations.

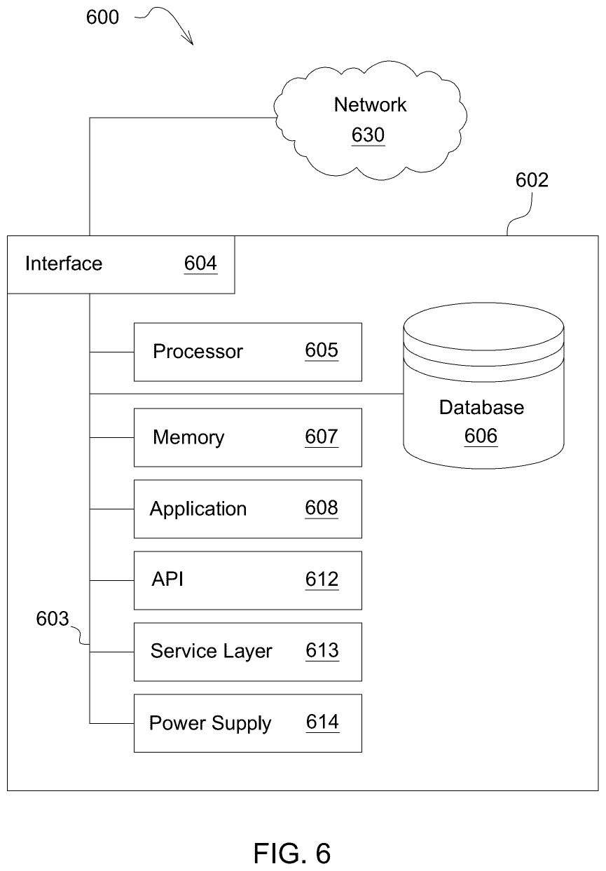

FIG. 6 is a block diagram of an example computer system 600 used to provide computational functionalities associated with described algorithms, methods, functions, processes, flows, and procedures described in the present disclosure, according to some implementations of the present disclosure. The illustrated computer 602 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 602 can include input devices such as keypads, keyboards, and touch screens that can accept user information. Also, the computer 602 can include output devices that can convey information associated with the operation of the computer 602. The information can include digital data, visual data, audio information, or a combination of information. The information can be presented in a graphical user interface (UI) (or GUI).

The computer 602 can serve in a role as a client, a network component, a server, a database, a persistency, or components of a computer system for performing the subject matter described in the present disclosure. The illustrated computer 602 is communicably coupled with a network 630. In some implementations, one or more components of the computer 602 can be configured to operate within different environments, including cloud-computing-based environments, local environments, global environments, and combinations of environments.

At a high level, the computer 602 is an electronic computing device operable to receive, transmit, process, store, and manage data and information associated with the described subject matter. According to some implementations, the computer 602 can also include, or be communicably coupled with, an application server, an email server, a web server, a caching server, a streaming data server, or a combination of servers.

The computer 602 can receive requests over network 630 from a client application (for example, executing on another computer 602). The computer 602 can respond to the received requests by processing the received requests using software applications. Requests can also be sent to the computer 602 from internal users (for example, from a command console), external (or third) parties, automated applications, entities, individuals, systems, and computers.

Each of the components of the computer 602 can communicate using a system bus 603. In some implementations, any or all of the components of the computer 602, including hardware or software components, can interface with each other or the interface 604 (or a combination of both), over the system bus 603. Interfaces can use an application programming interface (API) 612, a service layer 613, or a combination of the API 612 and service layer 613. The API 612 can include specifications for routines, data structures, and object classes. The API 612 can be either computer-language independent or dependent. The API 612 can refer to a complete interface, a single function, or a set of APIs.

The service layer 613 can provide software services to the computer 602 and other components (whether illustrated or not) that are communicably coupled to the computer 602. The functionality of the computer 602 can be accessible for all service consumers using this service layer. Software services, such as those provided by the service layer 613, can provide reusable, defined functionalities through a defined interface. For example, the interface can be software written in JAVA, C++, or a language providing data in extensible markup language (XML) format. While illustrated as an integrated component of the computer 602, in alternative implementations, the API 612 or the service layer 613 can be stand-alone components in relation to other components of the computer 602 and other components communicably coupled to the computer 602.

Moreover, any or all parts of the API 612 or the service layer 613 can be implemented as child or sub-modules of another software module, enterprise application, or hardware module without departing from the scope of the present disclosure.

The computer 602 includes an interface 604. Although illustrated as a single interface 604 in FIG. 6, two or more interfaces 604 can be used according to particular needs, desires, or particular implementations of the computer 602 and the described functionality. The interface 604 can be used by the computer 602 for communicating with other systems that are connected to the network 630 (whether illustrated or not) in a distributed environment. Generally, the interface 604 can include, or be implemented using, logic encoded in software or hardware (or a combination of software and hardware) operable to communicate with the network 630. More specifically, the interface 604 can include software supporting one or more communication protocols associated with communications. As such, the network 630 or the interface's hardware can be operable to communicate physical signals within and outside of the illustrated computer 602.

The computer 602 includes a processor 605. Although illustrated as a single processor 605 in FIG. 6, two or more processors 605 can be used according to particular needs, desires, or particular implementations of the computer 602 and the described functionality. Generally, the processor 605 can execute instructions and can manipulate data to perform the operations of the computer 602, including operations using algorithms, methods, functions, processes, flows, and procedures as described in the present disclosure.

The computer 602 also includes a database 606 that can hold data for the computer 602 and other components connected to the network 630 (whether illustrated or not). For example, database 606 can be an in-memory, conventional, or a database storing data consistent with the present disclosure. In some implementations, database 606 can be a combination of two or more different database types (for example, hybrid in-memory and conventional databases) according to particular needs, desires, or particular implementations of the computer 602 and the described functionality. Although illustrated as a single database 606 in FIG. 6, two or more databases (of the same, different, or combination of types) can be used according to particular needs, desires, or particular implementations of the computer 602 and the described functionality. While database 606 is illustrated as an internal component of the computer 602, in alternative implementations, database 606 can be external to the computer 602.

The computer 602 also includes a memory 607 that can hold data for the computer 602 or a combination of components connected to the network 630 (whether illustrated or not). Memory 607 can store any data consistent with the present disclosure. In some implementations, memory 607 can be a combination of two or more different types of memory (for example, a combination of semiconductor and magnetic storage) according to particular needs, desires, or particular implementations of the computer 602 and the described functionality. Although illustrated as a single memory 607 in FIG. 6, two or more memories 607 (of the same, different, or combination of types) can be used according to particular needs, desires, or particular implementations of the computer 602 and the described functionality. While memory 607 is illustrated as an internal component of the computer 602, in alternative implementations, memory 607 can be external to the computer 602.

The application 608 can be an algorithmic software engine providing functionality according to particular needs, desires, or particular implementations of the computer 602 and the described functionality. For example, application 608 can serve as one or more components, modules, or applications. Further, although illustrated as a single application 608, the application 608 can be implemented as multiple applications 608 on the computer 602. In addition, although illustrated as internal to the computer 602, in alternative implementations, the application 608 can be external to the computer 602.

The computer 602 can also include a power supply 614. The power supply 614 can include a rechargeable or non-rechargeable battery that can be configured to be either user- or non-user-replaceable. In some implementations, the power supply 614 can include power-conversion and management circuits, including recharging, standby, and power management functionalities. In some implementations, the power-supply 614 can include a power plug to allow the computer 602 to be plugged into a wall socket or a power source to, for example, power the computer 602 or recharge a rechargeable battery.

There can be any number of computers 602 associated with, or external to, a computer system containing computer 602, with each computer 602 communicating over network 630. Further, the terms “client,” “user,” and other appropriate terminology can be used interchangeably, as appropriate, without departing from the scope of the present disclosure. Moreover, the present disclosure contemplates that many users can use one computer 602 and one user can use multiple computers 602.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/−R, DVD-RAM, DVD-ROM, HD-DVD, and BLURAY.

The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

Wireless connections within the scope of the present disclosure include wireless protocols, such as, 802.15 protocols (e.g., a BLUETOOTH®), 802.11 protocols, 802.20 protocols (e.g., WI-FI®), or a combination of different wireless protocols.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

While the above describes example implementations of the present disclosure, these descriptions should not be viewed in a limiting sense. Rather, other variations and modifications may be made without departing from the scope and spirit of the present disclosure as defined in the appended claims.

1-20. (canceled)

21. A vehicle lighting system configured to alter illumination in response to a detected input, the vehicle illumination system comprising:
at least one light; and
an electronic controller comprising:
one or more processors; and
a non-transitory computer-readable storage medium coupled to the one or more processors and storing programming instructions for execution by the one or more processors, the programming instructions instruct the one or more processors to:
determine whether a first agricultural machine is at least partially located in a geospatial region having a defined boundary the encompasses a defined area; and
alter illumination provided by at least one light from a first illumination condition to a second illumination condition different from the first illumination condition in response to the determination that the first agricultural machine is at least partially located in the geospatial region.

22. The vehicle lighting system of claim 21, wherein the programming instructions to instruct the one or more processors to alter illumination provided by the at least one light includes programming instructions to instruct the one or more processors to alter one of a direction of illumination and an amount of illumination output from the at least one light.

23. The vehicle lighting system of claim 22, wherein the programming instructions to instruct the one or more processors to alter one of the direction of illumination and the amount of illumination from the at least one light includes programming instructions to instruct the one or more processors to one of activate and deactivate the at least one light.

24. The vehicle lighting system of claim 21, wherein the geospatial region is a region defined relative to a second agricultural machine.

25. The vehicle lighting system of claim 24, wherein a size of the geospatial region is dynamically changing.

26. The vehicle lighting system of claim 21, wherein the programming instructions include programming instructions to instruct the one or more processors to:
determine that the first agricultural machine is outside of the geospatial area; and
return the illumination provided by the at least one light to the first illumination condition in response to the determination that the first agricultural machine is outside of the geospatial area.

27. The vehicle lighting system of claim 21, wherein the programming instructions to alter illumination provided by at least one light from the first illumination condition to the second illumination condition different from the first illumination condition in response to the determination that the first agricultural machine is at least partially located in the geospatial region include programming instructions to instruct the one or more processors to:
determine a current illumination condition of the at least one light, and
alter illumination provided by at least one light from the current illumination condition to an altered illumination condition different from the current illumination condition.

28. The vehicle lighting system of claim 21, wherein the programming instructions further include programming instructions that instruct the one or more processors to:
determine whether the first agricultural machine has a selected heading, and
wherein the programming instructions that instruct the one or more processors to alter illumination provided by the at least one light from the first illumination condition to the second illumination condition different from the first illumination include programming instructions that instruct the one or more processors to alter illumination provided by the at least one light from the first illumination condition to the second illumination condition in response to the determination that the first agricultural machine is at least partially located in the geospatial region and the determination that the first agricultural machine has the selected heading.

29. The vehicle lighting system of claim 28, wherein the programming instructions that instruct the one or more processors to determine whether the first agricultural machine has a selected heading includes programming instructions that instruct the one or more processors to determine whether the first agricultural machine has a selected heading relative to a second agricultural machine, and
wherein the programming instructions that instruct the one or more processors to alter illumination provided by the at least one light from the first illumination condition to the second illumination condition in response to the determination that the first agricultural machine is at least partially located in the geospatial region and the determination that the first agricultural machine has the selected heading include programming instructions that instruct the one or more processors to alter illumination provided by the at least one light from the first illumination condition to the second illumination condition in response to the determination that the first agricultural machine is at least partially located in the geospatial region and the determination that the first agricultural machine has the selected heading relative to the second agricultural machine.

30. The vehicle lighting system of claim 28, wherein the selected heading is a range of selected headings of the first agricultural machine.
